(19) United States
(12) Patent Application Publication
(10) Pub. No.: US 2014/0143443 A1
(43) Pub. Date: May 22, 2014

(54) COMMUNICATION DEVICE, COMMUNICATION SYSTEM, AND COMPUTER PROGRAM PRODUCT

(71) Applicant: Kabushiki Kaisha Toshiba, Minato-ku (JP)

(72) Inventors: Ririka TAKAHASHI, Tokyo (JP); Yoshimichi Tanizawa, Kanagawa (JP); Hideaki Sato, Kanagawa (JP)

(73) Assignee: Kabushiki Kaisha Toshiba, Minato-ku (JP)

(21) Appl. No.: 14/036,208

(22) Filed: Sep. 25, 2013

(30) Foreign Application Priority Data
Nov. 19, 2012 (JP) 2012-253555

(51) Int. Cl. H04L 12/721

(52) U.S. Cl. CPC H04L 45/38
USPC 709/241

(57) ABSTRACT

According to an embodiment, a communication device is structured to be connected to a plurality of external devices. The communication device includes an acquisition unit and a selector. The acquisition unit is configured to acquire resource information that represents a resource of cryptographic keys available from each external device. The selector is configured to select a path from among a plurality of paths for one of the external devices, based on a bottleneck and a hop count of the resource on the path.

### CROSS-REFERENCE TO RELATED APPLICATION

This application is based upon and claims the benefit of priority from Japanese Patent Application No. 2012-253555, filed on Nov. 19, 2012; the entire contents of which are incorporated herein by reference.

### FIELD

An embodiment described herein relates generally to a communication device, a communication system, and a computer program product.

### BACKGROUND

A key sharing network is known that consists of a plurality of networked nodes which is mutually connected by a plurality of links. Each node has the function of generating and sharing a random number with adjacent nodes that are connected by links, as well as has the function of performing cryptographic communication over a link by using a random number as a cryptographic key (hereinafter, referred to as “a link key”). Moreover, some of the nodes also have the function of generating a cryptographic key (hereinafter, referred to as “an application key”), which is a random number, independent of the links; as well as have the function of transmitting the application key to a different node via a link.

In a key sharing network, an application has the function of acquiring an application key from a node; using that application key as a cryptographic key; and performing cryptographic communication with another application. At that time, the cryptographic communication can be performed using a network (hereinafter, referred to as “an application network”), such as the Internet, that is different than the key sharing network. Meanwhile, applications and nodes can be configured in an integrated manner. Alternatively, applications and nodes can be configured as terminals independent of each other, and application keys can be transmitted and received among them.

In a node, the function of generating a random number (a link key) and sharing it with adjacent nodes that are connected by links can also be implemented using, for example, a technology that is commonly called quantum cryptography or quantum key distribution (QKD).

In quantum key distribution, routing is performed in order to share an application key among the nodes that establish a key sharing network. That is, the transfer of an application key is done via a plurality of nodes. Accordingly, in a quantum cryptographic communication system, it is desirable to perform efficient routing while avoiding consumption and depletion of the link keys that are used in transferring an application key.

### BRIEF DESCRIPTION OF THE DRAWINGS

FIG. 1 is a diagram illustrating a structure example of a quantum cryptographic communication system according to an embodiment;

FIG. 2 is a diagram illustrating an exemplary sequence for sharing application keys in a key sharing network;

FIG. 3 is a diagram illustrating an exemplary sequence of operations performed in the OSPF protocol;

FIG. 4 is a diagram for explaining metric calculation;

FIG. 5 is a diagram illustrating a comparison example of hop counts of paths;

FIG. 6 is a block diagram of a node according to the embodiment;

FIGS. 7 to 11 are diagrams for explaining a routing algorithm according to the embodiment;

FIG. 12 is a flowchart for explaining an example of a path selecting operation performed according to the embodiment;

FIG. 13 is a diagram illustrating a network structure example;

FIGS. 14 to 25 are diagrams illustrating an exemplary sequence of operations for performing the routing protocol with respect to the network illustrated in FIG. 13;

FIG. 26 is a diagram illustrating a configuration example of a quantum cryptographic communication system according to a modification; and

FIG. 27 is an explanatory diagram for explaining a hardware configuration of a communication device according to the embodiment.

### DETAILED DESCRIPTION

According to an embodiment, a communication device is configured to be connected to a plurality of external devices. The communication device includes an acquisition unit and a selector. The acquisition unit is configured to acquire resource information that represents a resource of cryptographic keys available from each external device. The selector is configured to select a path from among a plurality of paths for one of the external devices, based on a bottleneck and a hop count of the resource on the path.

An exemplary embodiment of a communication device according to the invention is described below in detail with reference to the accompanying drawings.

There are times when the open shortest path first (OSPF) protocol is used as a protocol for determining the route (path) to share a cryptographic key in quantum key distribution (i.e., used as a routing protocol). In the OSPF protocol, the distance (i.e., the sum of costs of links included in each path) is used as a metric for performing routing (path control).

In a quantum cryptographic communication system, each node shares application keys using a link key on a key sharing network. When nodes encrypt application keys using link keys, it results in the consumption of link keys. That is because the nodes use the link keys in one-time pad. In other words, that is because a link key that is used once is thrown away. Hence, the exchange and the relay of an application key cannot be performed at a speed equal to or larger than the number of the shared link keys or the speed of sharing the link keys. In the case of exchanging an application key via a plurality of nodes, the sharing speed of the application key is regulated to the link having the smallest number of link keys or regulated to the link having the lowest sharing speed of link keys. In a cryptographic communication system, such links form a bottleneck thereby leading to a restriction on the throughput of cryptographic communication. Also, in a link in which link keys are depleted, the communication itself cannot be performed. Thus, in a quantum cryptographic communication system, it is desirable that the links forming a bottleneck be avoided as much as possible and sharing of application keys be done by selecting efficient paths.

On the other hand, if the attention is focused on the amount of consumption of link keys in the entire communication system; it can be said that, the more the number of links in a path is, the more the amount of consumption of link keys is. Since the link keys are used at the time of sharing application keys, they are a valuable system resource for determining the throughput of the applications. For that reason, as far as the entire communication system is concerned, it is desirable that the number of links via which an application key is shared be reduced and the amount of consumption of link keys is held down.

In this way, in a quantum cryptographic communication system, if the link keys are considered to be the constraint resource (key resource); then it is desirable that efficient routing be performed while avoiding consumption and depletion of the link keys.

In that regard, in a communication system according to the embodiment, a routing algorithm is implemented that enables efficient sharing of application keys while holding down the consumption of link keys as much as possible. With that, it becomes possible to reduce the amount of consumption of link keys in the entire communication system while not only avoiding depletion of link keys in particular nodes but also maintaining the throughput.

For example, in the communication system according to the embodiment, an algorithm for calculating resource information, which represents the resource of cryptographic keys (i.e., key resource) that can be provided to an application, is used as a metric of the routing algorithm. With that, the bottleneck (i.e., the value representing a bottleneck) is treated as a metric of route selection (path selection), and path selection not causing depletion of keys becomes possible. In addition, in the communication system according to the embodiment, the hop count is also treated as a metric. With that, it becomes possible to select a route in which the amount of consumption of link keys is held down.

Meanwhile, the value representing a bottleneck is, for example, the value of the link at which the bottleneck comes from. As described later, the value representing the bottleneck is the smallest value of costs from among the costs (resource) of the links in a path. In the following explanation, the value representing the bottleneck is sometimes simply referred to as “the bottleneck”.

The nodes constituting a key sharing network exchange usable key resource information and network information with each other. Regarding the path for sharing an application key, each node calculates the bottleneck of the key resource and calculates the hop count between the adjacent nodes. Then, with the bottleneck of the key resource and the hop count using as the metrics, each node implements an algorithm explained below and selects such a path in order to avoid that depletion of keys, which results in a slow key generation speed and a small stock of keys, as well as the consumption of keys in the entire communication system is held down.

Meanwhile, avoiding the bottleneck and reducing the hop count are different metrics. According to the order for selecting a path or weighting of metric evaluation, a number of variations for calculating a metric are possible. For example, by following a process (A) or a process (B) given below, a node selects such a path in which depletion of the link keys in particular links is avoided and the consumption of keys in the entire communication system is held down.
(A) With respect to the paths having the same metric “bottleneck of key resource”, path selection is performed by taking into account the metric “hop count”.
(B) Path selection is performed using a single metric in which the bottleneck as well as the hop count is taken into account.

The routing protocol can be implemented again, when the key resource varies in a large way. Although the bottleneck of key resource and the hop count in a path are treated as the metrics, other elements can also be treated as the metrics. Moreover, although the bottleneck is considered to be the first metric element and the hop count is considered to be the next metric element, the order of evaluation can also be reversed. That is, routing can be performed first using the hop counts in paths as the metric, and the bottlenecks can be evaluated when the hop counts are equal. Furthermore, it is also possible to adjust the weighting to which the bottleneck of key resource as well as the hop count in a path is reflected in the metrics. That becomes possible by, for example, calculating the metric by weighting the bottleneck of key resource and the hop count.

Taking into account the bottlenecks of key resource is related to the speed (throughput) of sharing the application keys or related to the tendency of avoiding depletion of link keys in particular links. Moreover, taking into account the hop counts is related to the amount of consumption of keys in the entire communication system. Thus, depending on the applications for which the quantum cryptographic communication is applied, it works well to use different metrics.

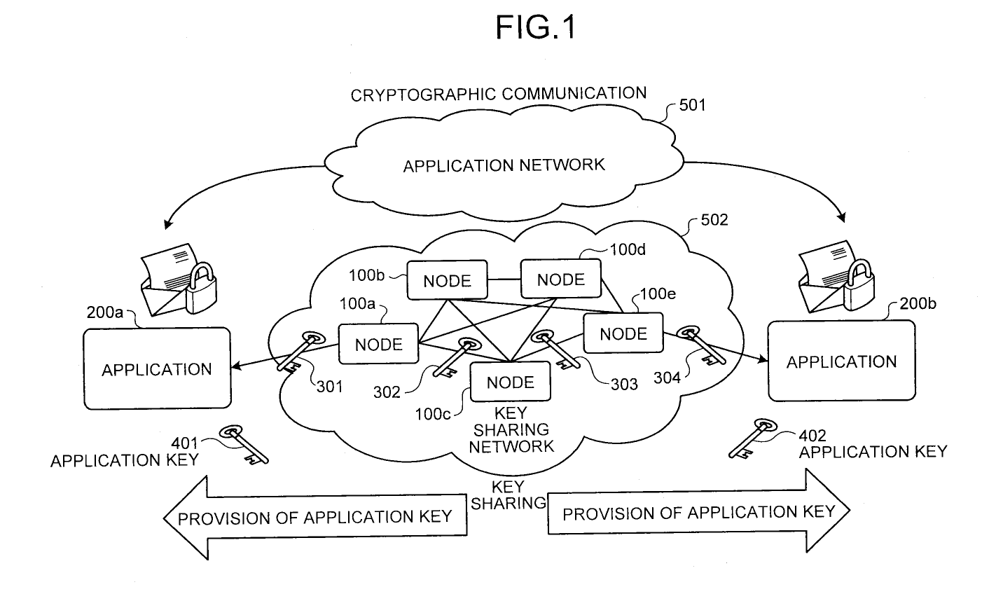

FIG. 1 is a diagram illustrating a configuration example of the quantum cryptographic communication system according to the embodiment. FIG. 1 illustrates an example of a case in which the nodes and the applications are configured independent of each other. The quantum cryptographic communication system includes nodes 100a to 100e that each function as a communication device; and includes applications 200a and 200b. The nodes 100a to 100e share link keys (link keys 301 to 304) via a key sharing network 502. The applications 200a and 200b perform cryptographic communication using application keys (application keys 401 and 402) via an application network 501.

When there is no need to distinguish between the nodes 100a to 100e, they are simply referred to as nodes 100 or any one of them is referred to as a node 100. Similarly, when there is no need to distinguish between the applications 200a and 200b, they are simply referred to as applications 200 or any one of them is referred to as an application 200. Meanwhile, the number of nodes 100 is not limited to five, and the number of applications 200 is not limited to two.

As described above, the nodes 100a to 100e have the function of generating and sharing a random number with respective adjacent nodes; as well as have the function of using the generated random number as a link key and performing cryptographic communication over the key sharing network 502. Each node 100 can also have the function of generating a random number independent of the links, as well as have the function of transmitting the random number to a different node.

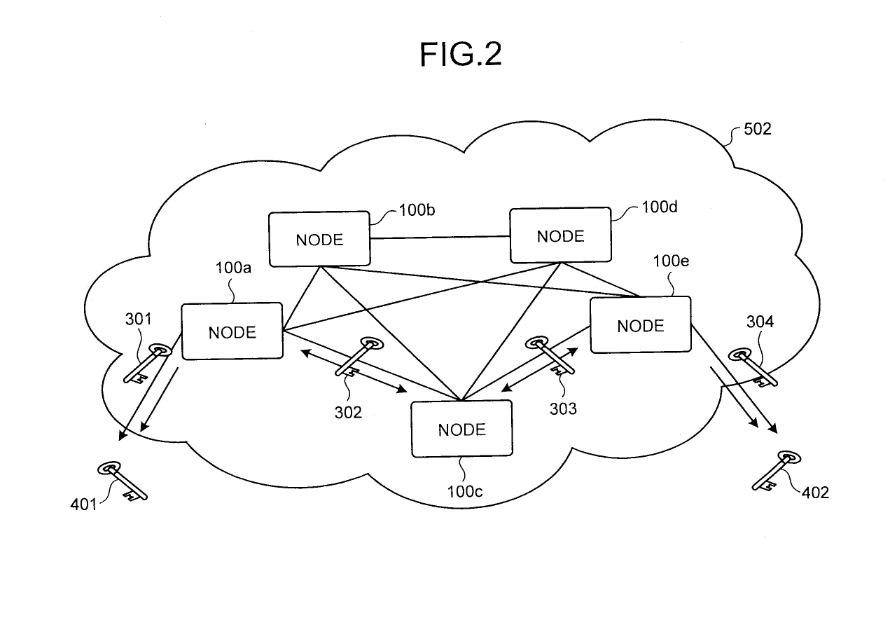

FIG. 2 is a diagram illustrating an exemplary sequence for sharing application keys in the key sharing network. Each node 100 generates a link key with another node 100. In FIG. 2 is illustrated an example in which the link key 302 is shared between the node 100a and the node 100c, and the link key 303 is shared between the node 100c and the node 100e.

Each node 100 performs routing to share an application key. Then, using link keys, each node 100 shares (transfers) the application key over the path determined as a result of routing. FIG. 2 illustrates an example in which application keys are shared between the node 100a and the node 100e. Consequently, the node 100a provides the application key 401, while the node 100e provides the application key 402.

Given below is the explanation of a sequence for deciding on routing tables in the key sharing network with the use of the OSPF protocol that is a known routing protocol. In the OSPF protocol, each node 100 sends a message called a link state; and shares with the other nodes 100 the information such as the state of the links to which the node 100 is connected, the network addresses of those links, and the costs of the links. A link state contains information (network information) such as the connection of a particular node with other nodes as well as the manner of connection. Each node 100 that receives a link state gets to know the network structure based on the corresponding network information. Then, each node 100 builds a table representing the network information (i.e., builds a link state database). Then, each node 100 implements the Dijkstra algorithm; creates a shortest path tree, with itself as the start point, by referring to the link state database; and creates a routing table.

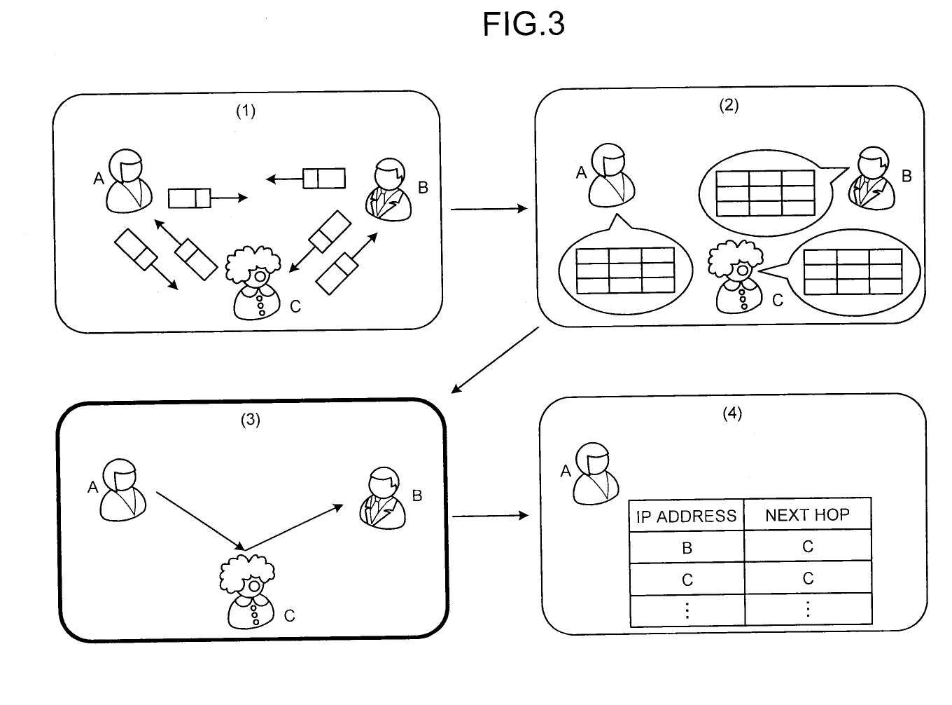

FIG. 3 is a diagram illustrating an exemplary sequence of operations performed in the OSPF protocol. Each node 100 performs routing using the OSPF protocol according to the sequence of processes (1) to (4) illustrated in FIG. 3.
(1) Each node 100 shares its link state with the other nodes 100. The link state contains, for example, the states of the links to which the node 100 is connected; the network addresses of those links, and the costs of those links.
(2) Each node 100 refers to all link states and creates a table representing the network information (i.e., creates a link state database).
(3) Each node 100 implements the Dijkstra algorithm and creates a shortest path tree, with itself as the start point, from the link state database.
(4) Each node 100 creates a routing table (such as a table in which IP addresses and next hops are stored in a corresponding manner) from the shortest path tree.

Explained above was the basic sequence of processes for determining routing tables in the key sharing network. From among the processes in that sequence, the embodiment is related mainly to the creation of the shortest path tree explained at the process (3). Apart from that; the processes (1), (2), and (4) can be implemented in an identical manner to the conventional processes. However, as described below, some portion of the information shared as a result of implementing the process (1) contains information specific to the embodiment.

A metric calculation method adopted in the routing protocol according to the embodiment is explained below. First, given below is the data associated to the links and the nodes 100 that constitute the key sharing network.

The data associated to links:
The cost (resource information): the key generation speed
The cost (resource information): the stock of keys

The data associated to nodes 100:
The database representing the network structure (link state database)
The established information as the shortest path tree
The bottleneck from the start point to another node 100
The hop count from the start point to another node 100
The next hop

In the embodiment, the following two types of cost (resource information) are used as the data associated to links: the generation speed of link keys (key generation speed) and the stock of link keys (stock of keys). The key generation speed represents the speed at which link keys are shared between the nodes 100 by performing quantum key distribution. For each link, the key generation speed differs due to the effect of configuration parameters or the environment of the nodes 100 that operate while being connected to that link. The stock of keys represents the number of still-unused link keys from among the link keys shared among a plurality of nodes 100 by performing quantum key distribution. The stock of keys increases as a result of performing quantum key distribution, and decreases as a result of the consumption of link keys during key routing. In the embodiment, the abovementioned two types of cost are treated as the cost of a link. In the following explanation, the abovementioned two types of cost are collectively referred to as the key resource. Meanwhile, the key resource is not limited to the abovementioned two types of cost. For example, it is also possible to use only the key generation speed as the key resource or to use only the stock of keys as the key resource.

As described above, each node 100 maintains a link state database, which represents the structure (relations of connection) of the network within an area, as the information required during the calculation of the shortest path. Moreover, each node 100 holds “the established information” as the shortest path tree, the cost (resource information) of each link from the start point to another node 100, the hop count from the start point to another node 100, and the next hop.

The established information as the shortest path tree indicates, for each external device (another node 100), whether or not the shortest path up to that particular node 100 has been established. If the shortest path has not been established, it indicates that the path up to that particular node 100 is no more than a candidate for the shortest path (a shortest path candidate).

The bottleneck from the start point to another node 100 indicates the cost (resource information) of links when the shortest path candidate is taken to reach the other node 100. The hop count from the start point to another node 100 indicates the hop count when the shortest path candidate is taken to reach the other node 100. Herein, for each other node 100, the cost of each link from the start point to the other node 100 and the hop count from the start point to the other node 100 is held.

The next hop indicates the next hop in a shortest path candidate.

In the Dijkstra algorithm implemented in the OSPF protocol, the distance serves as the metric. In contrast, in a key consumption control routing protocol according to the embodiment, the bottleneck in a path is used instead of the distance in metric calculation. Herein, the bottleneck is introduced as the metric in order to maintain the key generation speed and the stock of keys equal to or larger than a certain value and to ensure that there is no hindrance in the data communication speed in the application network.

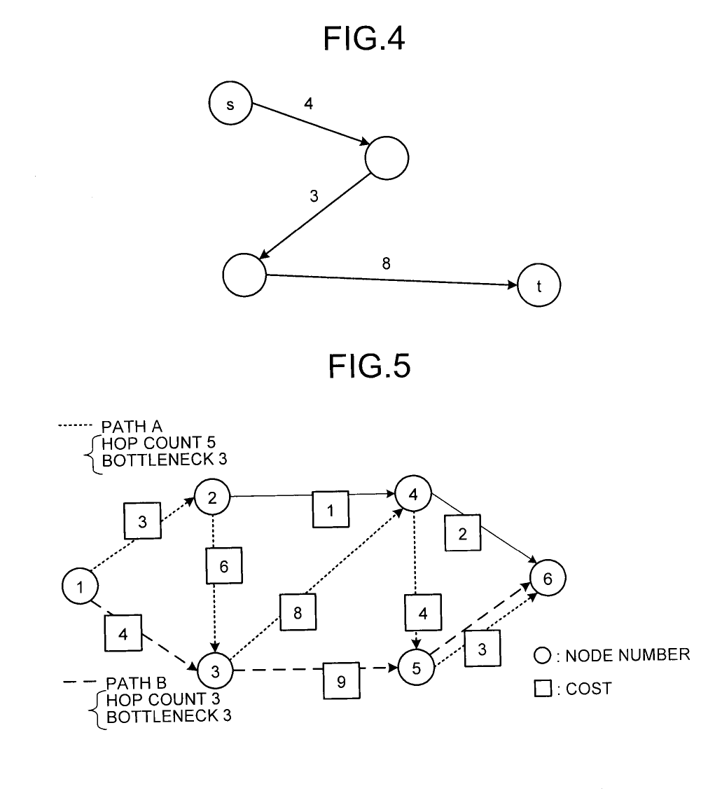

FIG. 4 is a diagram for explaining metric calculation. With reference to the example illustrated in FIG. 4, the explanation is given about the distance and the bottleneck treated as the metrics. In FIG. 4, the numbers assigned to the links indicate the respective costs.

In the case of treating the distance as the metric, the sum of costs of the links included in the path from “s” to “t” illustrated in FIG. 4 becomes the metric (distance) of the path. In the case of treating the bottleneck as the metric, the smallest value of costs from among the costs of the links included in the path from “s” to “t” becomes the metric (bottleneck) of the path.

In the example illustrated in FIG. 4, the distance is calculated as the sum of costs of the links included in the path. Hence, the distance becomes 4+3+8=15. That is, the metric of this path is equal to 15. On the other hand, the bottleneck is the smallest value of costs from among the costs of the links included in the path. Thus, the bottleneck is min{4, 3, 8}=3. That is, the metric of this path is equal to 3.

As described above, in the OSPF protocol, the Dijkstra algorithm is implemented with the distance treated as the metric. In the key consumption control routing algorithm, the routing operation is performed with the bottleneck treated as the metric. However, if only the bottleneck is treated as the metric, then there is no criterion to deal with the case of having a plurality of paths having the same bottleneck. For that reason, there is a possibility that a longer path having a larger hop count gets selected, depending on the implementation of the path evaluation order or depending on the configuration of the target network. That is, there is a possibility that the amount of link key consumption in the communication system increases.

FIG. 5 is a diagram illustrating a comparison example of the hop counts of the paths that are acquired by treating the bottleneck as the metric. In FIG. 5, the numbers assigned to the nodes represent node numbers, and the numbers assigned to the links represent link numbers. In the following explanation, the node having a node number n (where n is an integer equal to or larger than one) assigned thereto is sometimes referred to as node n.

In a path A including node 1→node 2→node 3→node 4→node 5→node 6, the bottleneck is equal to 3 and the hop count is equal to 5. Similarly, in a path B including node 1→node 3→node 5→node 6, the bottleneck is equal to 3 but the hop count is equal to 3. If it is assumed that link keys equal in number to the bottleneck are consumed in each link included in a path, then 15 link keys are consumed in the path A. In contrast, the consumption of link keys is held down to 9 in the path B. Hence, as compared to the path A having the larger hop count, the path B makes it possible to hold down the key consumption of the entire communication system.

Hence, in addition to the bottleneck of a path from the source node 100 to the destination node 100, the hop count of that path is also treated as a metric. As a result, from among the paths having the same bottleneck, the path having the smallest hop count gets selected. With that, it becomes possible to perform routing in which the key consumption of the entire communication system can be further held down.

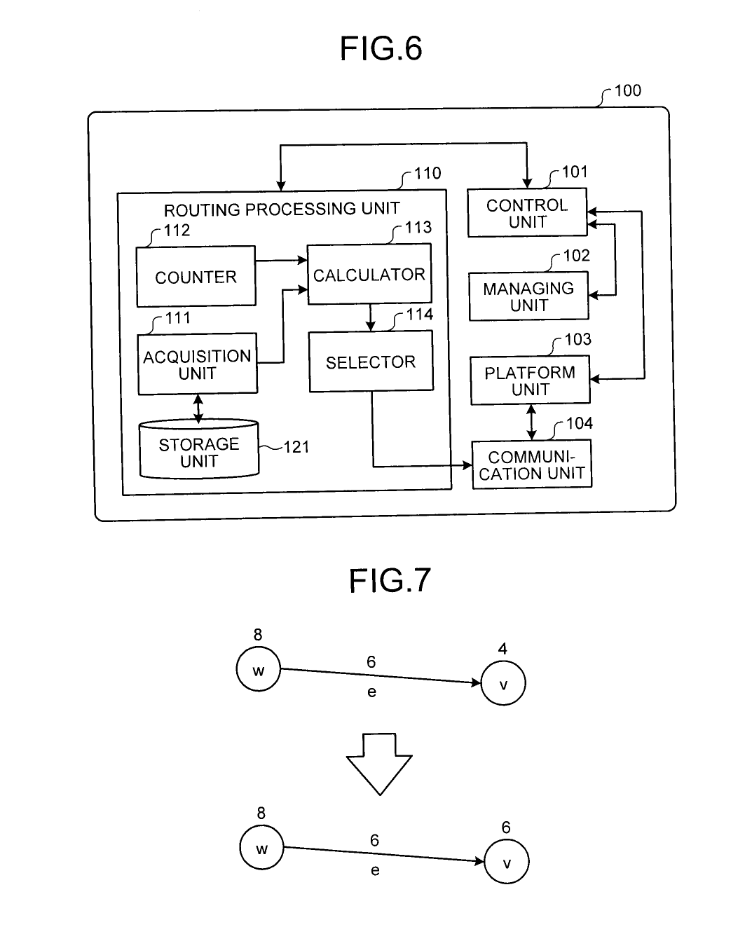

FIG. 6 is a block diagram illustrating an exemplary functional configuration of the node 100 according to the embodiment. The node 100 includes a control unit 101, a managing unit 102, a platform unit 103, a communication unit 104, and a routing processing unit 110. Herein, the routing processing unit 110 includes a storage unit 121, an acquisition unit 111, a counter 112, a calculator 113, and a selector 114.

The storage unit 121 is used to store a routing table and a variety of information such as the resource information of each node 100. For example, the storage unit 121 is used to store, for each node 100, the resource information (the key generation speed and the stock of keys) acquired from that node 100.

The acquisition unit 111 acquires, from another node 100, the resource information of link keys that can be provided by that other node 100; and acquires network information from that other node 100.

The counter 112 refers to, for example, the network information and acquires the hop counts of the shortest path candidates to reach to another node 100.

The calculator 113 calculates the metrics from the bottlenecks and the hop counts. Explained below are examples of specific metric calculation methods implemented in the processes (A) and (B) described above.
(A1) The bottlenecks and the hop counts are set in separate areas; and when the bottlenecks are equal, the hop counts are compared.
(B1) Formulae for calculating the metric including the bottleneck (BN) and the hop count (Hop) are created. Two exemplary formulae are given below.

metric=BN+1/(Hop) (E1)

metric=BN+(1−Hop/10) (E2)

For example, in formula E1, when BN=4 and Hop=2, metric becomes equal to 4+½=4.5. For example, in formula E2, when BN=4 and Hop=2, metric becomes equal to 4+(1−2/10)=4.8.

In the process (A1), the bottleneck as well as the hop count up to each node 100 is held, and the comparison of the hop counts is performed only when the bottlenecks are equal. In the process (B1), a calculation formula representing the metric is created in advance, and the metric is calculated using the bottleneck and the hop count up to each node 100.

In the processes (A1) and (B1), the result of routing by using calculated metrics is the same. In the process (B1), in an identical manner to the known Dijkstra algorithm, a single type of metric is used. For that reason, much of the existing implementation may be reusable. However, in the process (B1), it is important to note that accurate metric calculation is possible only when the hop count is equal to or smaller than 10.

Meanwhile, the abovementioned formulae for calculating the metric are only exemplary, and the metric calculation is not restricted to those formulae. Alternatively, for example, another formula can be used in which the result of adding a weighted bottleneck and a weighted hop count is treated as the metric. In that case, an arbitrary coefficient (weight) can be assigned to the bottleneck and the hop count.

The selector 114 selects, from among a plurality of candidates of paths for reaching an external device (another node 100), a single path based on the metrics (i.e., selects a path having the best metric).

The control unit 101 controls the processes performed in the corresponding node 100. For example, the control unit 101 is in charge of starting up the other constituent elements of the corresponding node 100.

The managing unit 102 manages the key resource, such as the key generation speed and the stock of keys, of the links to which the corresponding node 100 is connected.

The platform unit 103 provides operating system functionality, basic network functionality, and security functionality of a computer that are necessary for management and operations of the other constituent elements in the corresponding node 100.

The communication unit 104 performs communication with another node 100 that is connected to the corresponding node 100. The communication unit 104 generates a random number using quantum cryptography and shares the random number with the other node 100 connected via a link, as well as manages the generated random number as a link key. Moreover, the communication unit 104 is used by other the constituent elements while communicating data with the other node 100 connected via a link. The data that is exchanged with the other node 100 via the communication unit 104 contains the data of an application key. Usually, such data is exchanged by performing cryptographic communication using a link key managed in the corresponding node 100.

Meanwhile, the abovementioned constituent elements (the control unit 101, the managing unit 102, the platform unit 103, the communication unit 104, and the routing processing unit 110) can be implemented by running computer programs in a processing unit such as a central processing unit (CPU), that is, can be implemented using software; or can be implemented using hardware such as an integrated circuit (IC); or can be implemented using a combination of software and hardware. Moreover, the storage unit 121 can be configured using any of the commonly-used storage medium such as a hard disk drive (HDD), an optical disk, a memory card, or a random access memory (RAM).

Explained above was the configuration of the nodes 100 according to the embodiment. However, that explanation is only exemplary.

Given below is a detailed explanation of the key consumption control routing protocol according to the embodiment. The following explanation is about the basic sequence of operations performed in the key consumption control routing protocol. Herein, the explanation is given about processes (S1) to (S9) in which the link states are shared among the nodes 100 so as to know the network structure, and the shortest path tree is created prior to the creation of routing tables. In the following explanation, in order to indicate the nodes (joints) of the shortest path tree (tree structure) corresponding to the nodes 100 functioning as devices (communication devices), sometimes the term “node” is written instead of using any symbol.
(S1) Set an initialization label to all nodes.
(S2) Acquire the bottleneck with respect to each node connected to the start point.
(S3) From among the nodes connected to the start point, establish the value of the node having the largest bottleneck.
(S4) With respect to all nodes connected to the established node, newly calculate the bottleneck in the path from the start point.
(S5) If the newly-calculated bottleneck is larger than the already-held bottleneck, update the bottleneck and hold the new path. Then, delete the previous path that is not to be used anymore.
(S6) If the already-held bottleneck is larger than the newly-calculated bottleneck, then hold the current bottleneck and the path. Then, delete the newly-calculated path that is not to be used anymore.
(S7) If the newly-calculated bottleneck is equal to the already-held bottleneck, acquire the hop count of each path up to that node and hold the path having the smallest hop count.
(S8) From among the un-established nodes, establish the value of the node having the largest bottleneck from the start point.
(S9) Repeat the processes (S4) to (S8) until the values of all nodes are established.

Explained below is the routing algorithm according to the embodiment. In this routing algorithm, unlike the Dijkstra algorithm used in the OSPF protocol in which the distance is treated as the metric, the bottleneck and the hop count are treated as the metrics. First of all, the explanation is given about the notation used in the routing algorithm according to the embodiment.

s: start point

V: set of points of the entire graph

VP: set of points for which the bottlenecks are established

V\VP: set of points for which the bottlenecks are not established

BN[n]: bottleneck up to a point n

hop[n]: hop count up to the point n

cost[1]: cost of an edge 1

path[n]=1: path to the point n via the edge 1

The following is the explanation of an example of the routing protocol according to the embodiment.
(S11) Select the start point s. Set VP:=φ, BN[s]:=0, and hop[s]:=0 (path[s]:=0). Regarding points v other than the start point s; set BN[v]:=−1, and hop[v]:=0 (path[v]:=−1). Herein, it is assumed that the points v are not included in V\{s}.
(S12) Repeat the following operations until V=VP is satisfied.

(S12a) Acquire a point w for which BN[w]=max{BN[v]|vεV\VP} is satisfied (i.e., acquire a point w having the largest bottleneck value from among the points for which the bottlenecks are not established).

(S12b) Set VP:=VP∪{w} (i.e., add the point w to the set of points for which the bottlenecks are established).

With respect to each edge e=(w, v) having the point w as the start point, perform the following processes.
if BN[w]>cost(e)>BN[v] then BN[v]=cost(e),
   hop[v]:=hop[w]+1 (path(v):=e)
if cost(e)>BN[w]>BN[v] then BN[v]=BN[w],
   hop[v]:=hop[w]+1 (path(v):=e)
      (Update if the bottleneck up to the point w as well as the cost of the edge e is larger than that of the point v)
if BN[w]≧BN[v]=cost(e) and hop[v]>hop[w]+1
   then BN[v]=cost(e), hop[v]:=hop[w]+1 (path(v):=e)
if cost(e)>BN[v]=BN[w] and hop[v]>hop[w]+1
   then BN[v]=BN[w], hop[v]:=hop[w]+1 (path(v):=e)
      (If the bottleneck up to the point w is equal to the bottleneck of the path from the edge e, compare the hop counts. Update if the hop count from the point w is smaller than the already-held hop count for the point v).

Regarding the process (S12b) in the abovementioned algorithm, the explanation is given below with reference to FIGS. 7 to 11. Consider a link e=(w, v), where w represents the source node and v represents the destination node.

FIG. 7 is a diagram illustrating an example in which, when BN[w]>cost(e)>BN[v] is satisfied; BN[v]=cost(e) is satisfied and hop[v]:=hop[w]+1 (path(v):=e) is satisfied. Moreover, in FIG. 7 is illustrated an example in which the bottleneck up to the node w is equal to 8, the bottleneck of the path reaching the node v without passing through the node w is equal to 4, and the cost of the link e is equal to 6. Regarding the bottleneck up to the node v, the newly-connected path including the link e has a better (larger) bottleneck than the current bottleneck 4. For that reason, the link e becomes the bottleneck and the value representing the bottleneck becomes 6. In this way, when the cost of a link is smaller than the bottleneck of the source node, the bottleneck up to the destination node is updated with the cost of the link.

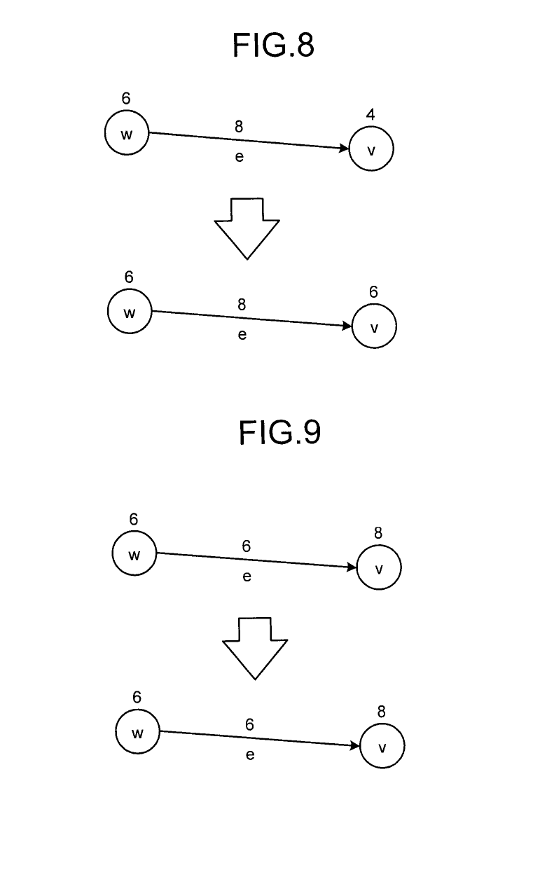

FIG. 8 is a diagram illustrating an example in which, when cost(e)>BN[w]>BN[v] is satisfied; BN[v]=BN[w] is satisfied and hop[v]:=hop[w]+1 (path(v):=e) is satisfied. Moreover, FIG. 8 illustrates an example in which the bottleneck up to the node w is equal to 6, the bottleneck of the path for reaching the node v without passing through the node w is equal to 4, and the cost of the link e is equal to 8. Regarding the bottleneck up to the node v, the newly-connected path including the link e has a better (larger) bottleneck than the current bottleneck 4. On the other hand, the cost of the link e is not the bottleneck (i.e., the bottleneck up to the node w is larger than 6). For that reason, in a similar way to the bottleneck up to the node w, the bottleneck up to the node v becomes 6. In this way, when the bottleneck up to the source node is smaller than the cost of a newly-connected link, the bottleneck up to the destination node is updated to the bottleneck up to the source node.

FIG. 9 is a diagram illustrating an example in which the bottleneck up to the destination node is not updated. As illustrated in FIG. 9, the bottleneck up to the node w, the cost of the link e, and the bottleneck up to the node v are compared. If the bottleneck of the path for the node v without passing through the node w has the largest value, then the path including the link e cannot be the shortest path. Hence, the bottleneck is not updated.

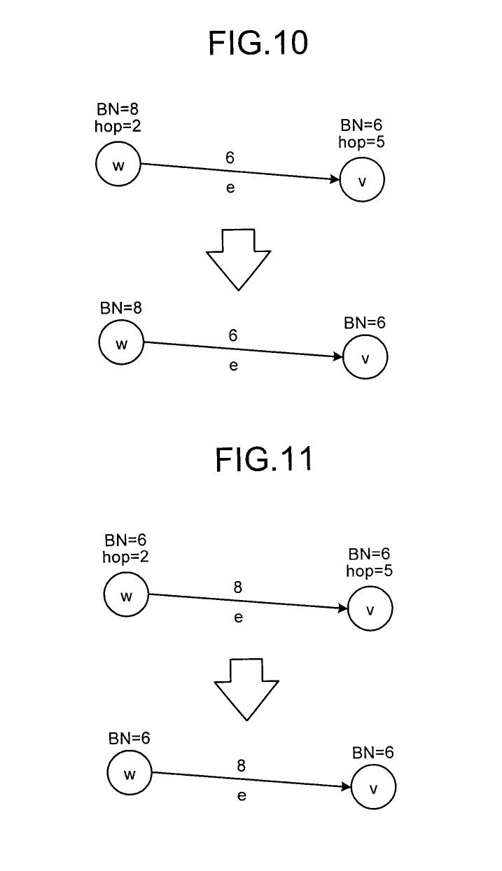

FIG. 10 is an example illustrating an example in which, when BN[w]≧BN[v]=cost(e) is satisfied and hop[v]>hop[w]+1 is satisfied; BN[v]=cost(e) is satisfied and hop[v]:=hop[w]+1 (path(v):=e) is satisfied. As illustrated in FIG. 10, when the bottleneck up to the node v as well as the cost of the link e is equal to 6 and when the bottleneck of the path for reaching the node w is equal to 8 and larger than 6, the hop counts are compared. As illustrated in FIG. 10, assume that the hop count up to the node w is 2 and the hop count up to the node v is 5. In that case, even if the node v is reached from the node w via the link e, the hop count is 2+1=3, which is smaller than the hop count of 5 up to the node v. For that reason, the path up to the node v is updated to the path that takes the link e.

FIG. 11 is a diagram illustrating an example in which, when cost(e)>BN[v]=BN[w] is satisfied and when hop[v]>hop[w]+1 is satisfied; BN[v]=BN[w] is satisfied and hop[v]:=hop[w]+1 (path(v):=e) is satisfied. As illustrated in FIG. 11, when the bottleneck up to the node v as well as the bottleneck up to the node w is equal to 6 and when the cost of the link e is equal to 8 and larger than 6, the hop counts are compared. As illustrated in FIG. 11, assume that the hop count up to the node w is 2 and the hop count up to the node v is 5. In that case, even if the node v is reached from the node w via the link e, the hop count is 2+1=3, which is smaller than the hop count of 5 up to the node 5. For that reason, the path up to the node v is updated to the path that takes the link e.

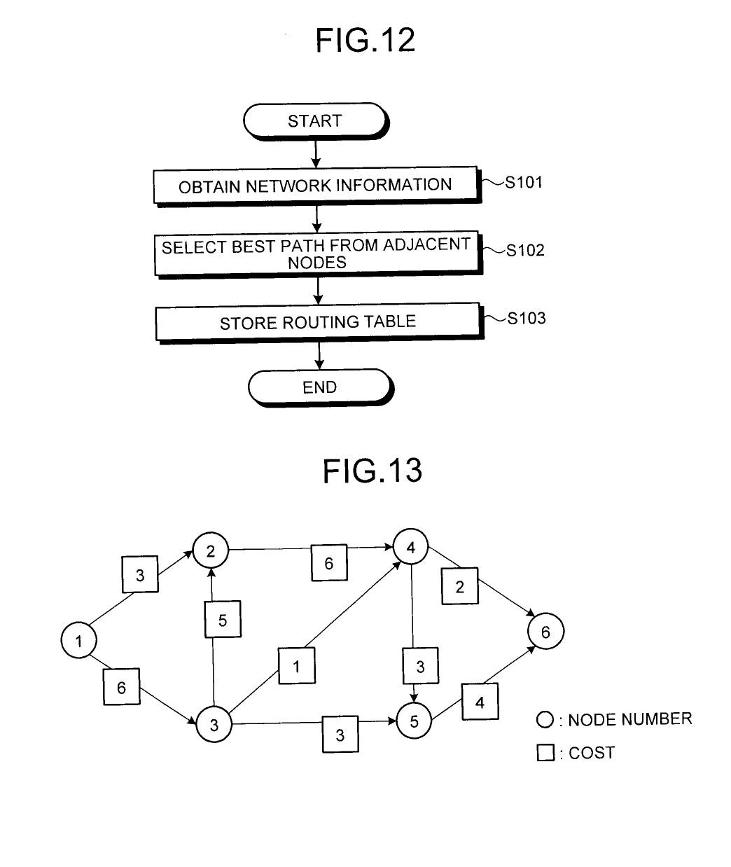

Explained below with reference to FIG. 12 is a path selecting process performed by the node 100 configured in the abovementioned manner according to the embodiment. FIG. 12 is a flowchart for explaining an example of the path selecting process performed according to the embodiment.

First, the acquisition unit 111 requires, from another node 100, the resource information of link keys that can be provided by that other node 100; and requires the network information from that other node 100 (Step S101).

In the case of implementing the sequence (A) (or the sequence (A1)), the counter 112 counts the hop counts of the shortest path candidates for the other node 100. The hop counts are referred to when a plurality of path candidates having the same bottleneck is required. In the case of implementing the sequence (B) (or the sequence (B1)), the calculator 113 calculates the metric including the bottlenecks and the hop counts.

Then, the selector 114 follows any one of the sequences (A) and (B) and, with respect to each other node 100, selects the path having the best cost (taking into account the bottlenecks and the hop counts) from among the paths for the node 100 (Step S102).

The routing processing unit 110 creates a routing table from the selected path (the shortest path tree) and stores the routing table in the storage unit 121 (Step S103).

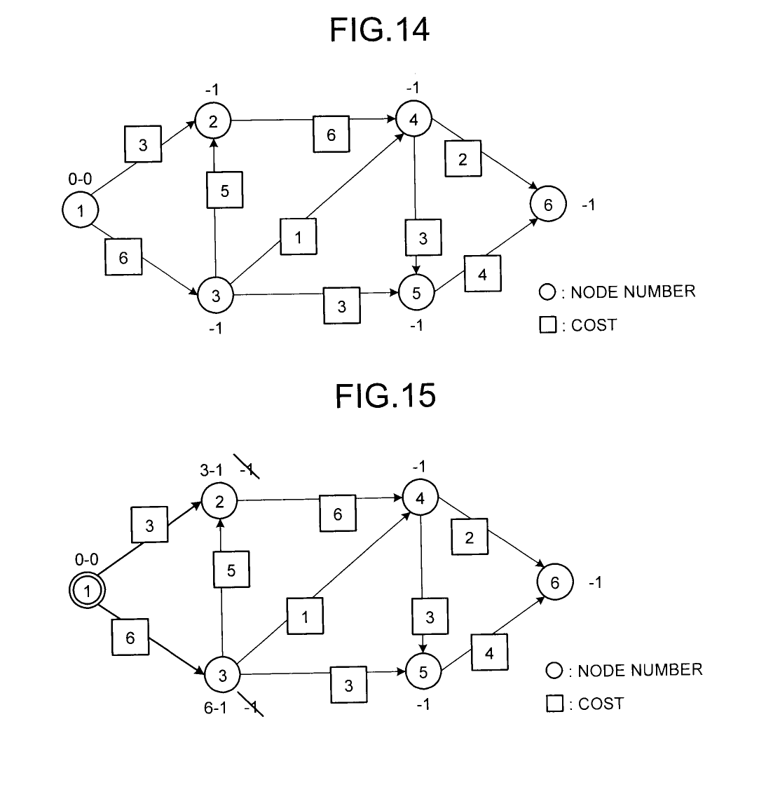

Given below is the explanation of a specific example of the path selection operation (routing) performed by the selector 114. The following explanation is given with reference to a network illustrated in FIG. 13 as an example. FIGS. 14 to 25 are diagrams illustrating an exemplary sequence of processes for performing the routing protocol with respect to the network illustrated in FIG. 13.

Herein, the numbers assigned to the nodes (i.e., the numbers enclosed in circles) represent node numbers. Similarly, the numbers assigned to the links (i.e., the numbers enclosed in quadrangles) represent the costs of links. Herein, the cost of a link indicates, for example, the key generation speed and the stock of keys. The two numbers written close to a node represent the cost to reach that node. In the embodiment, the cost is expressed in the format of “bottleneck-hop count”. Moreover, a double-circled node represents a node for which the shortest path up to that node is established.

Herein, the explanation is given about operations in which the link states are shared among the nodes so that it becomes possible to know the network structure, and the shortest path tree is created prior to the creation of routing tables. Although the explanation is given regarding an example of a one-way network, the shortest path tree can be acquired in an identical manner even in the case of a two-way network.

Firstly, the cost for reaching each node is initialized to −1 (FIG. 14). Herein, the initial value of −1 is only exemplary. That is, considering the fact that the cost is an integer, any negative value can be set as the initial value. Regarding the node 1 that is the source node (hereinafter, also referred to as the “source node 1”), the cost is set (to “0-0”) having the bottleneck equal to 0 and the hop count equal to 0; and the shortest path is established.

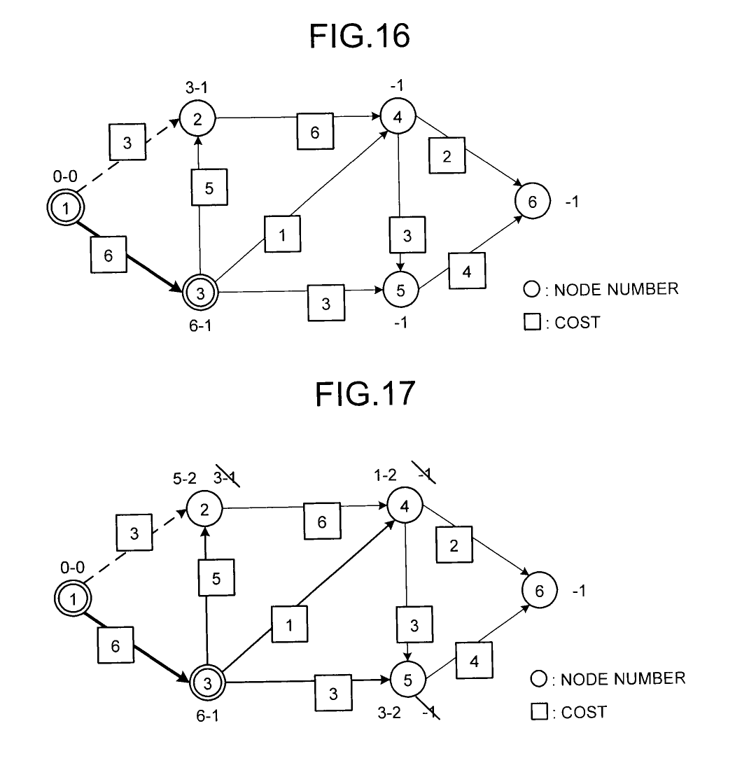

The node 2 connected to the node 1 is assumed to have the bottleneck equal to 3 and the hop count equal to 1. Moreover, the node 3 is assumed to have the bottleneck equal to 6 and the hop count equal to 1 (FIG. 15). Of the node 2 and the node 3, the node 3 having the better bottleneck has the shortest path established in which the bottleneck is equal to 6 and the hop count is equal to 1 (FIG. 16).

Hence, the node 1 and the node 3 become the established nodes, and the node 3 itself becomes the next hop between the source node 1 and the destination node 3.

The node 2 that is connected to the node 3 is updated to have the bottleneck equal to 5 and the hop count equal to 2. The node 4 is updated to have the bottleneck equal to 1 and the hop count equal to 2. The node 5 is updated to have the bottleneck equal to 3 and the hop count equal to 2 (FIG. 17).

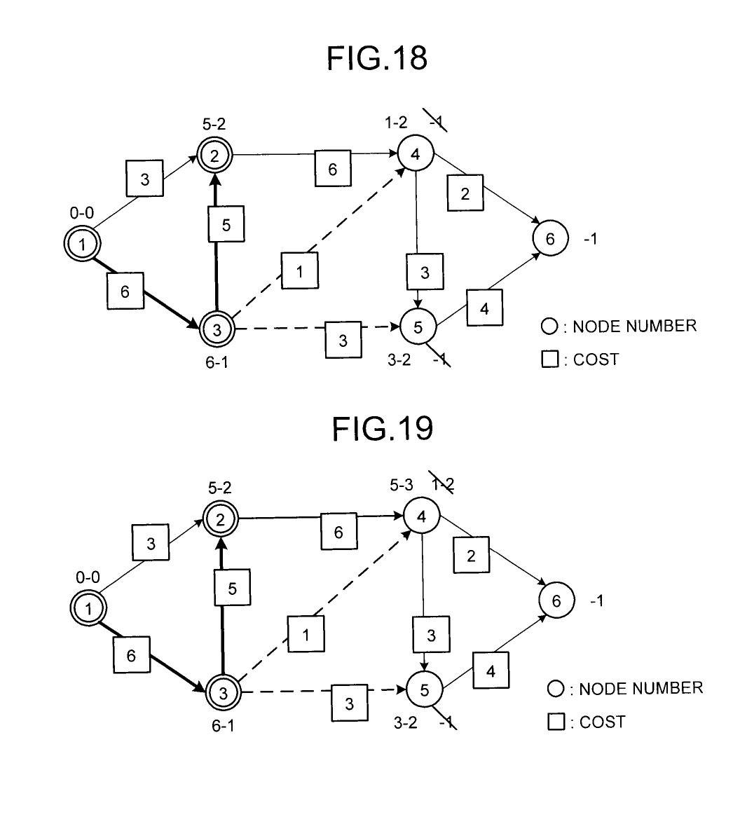

Regarding the node 2 having the best cost, the shortest path is established with the bottleneck equal to 5 and the hop count equal to 2 (FIG. 18). Thus, the node 1, the node 3, and the node 2 become the established nodes; and the node 3 becomes the next hop between the source node 1 and the destination node 2.

The node 4 that is connected to the node 2 is updated to have the bottleneck 5 and the hop count 3 (FIG. 19).

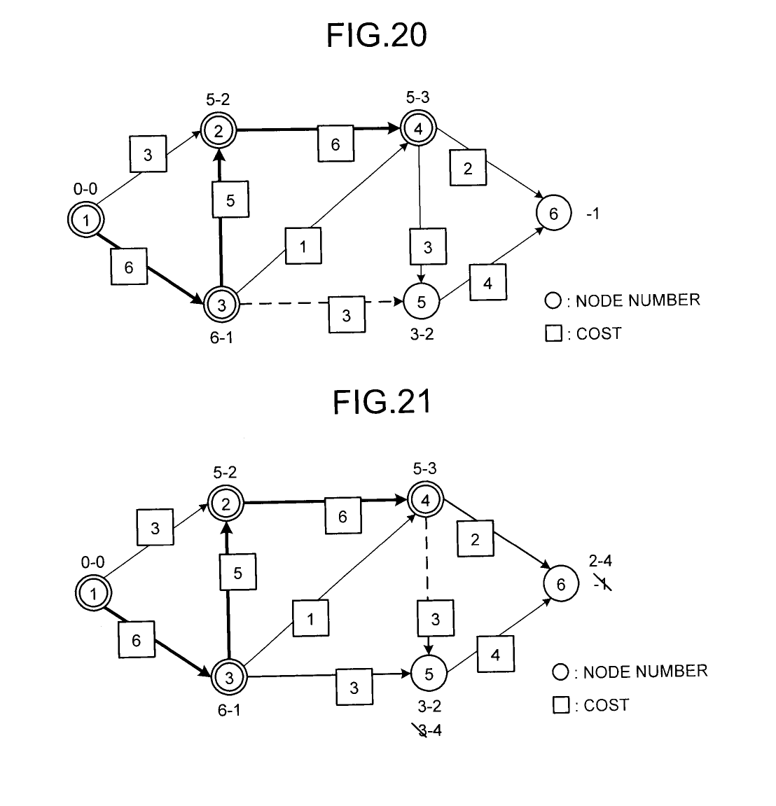

Regarding the node 4 having the best cost, the shortest path is established with the bottleneck equal to 5 and the hop count equal to 3 (FIG. 20). Thus, the node 1, the node 3, the node 2, and the node 4 become the established nodes; and the node 3 becomes the next hop between the source node 1 and the destination node 4.

The node 5 that is connected to the node 4 has the bottleneck equal to 3 and the hop count equal to 4. However, since the hop count is large, the node 5 is not updated. The node 6 is updated to have the bottleneck equal to 2 and the hop count equal to 4 (FIG. 21).

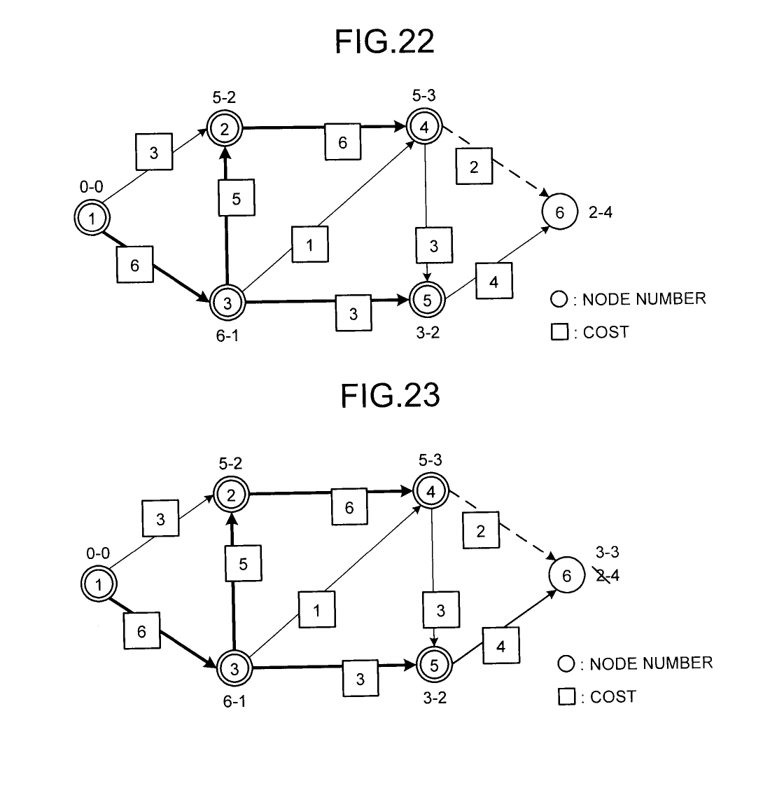

Regarding the node 5 having the best cost, the shortest path is established with the bottleneck equal to 3 and the hop count equal to 2 (FIG. 22). Thus, the node 1, the node 3, the node 2, the node 4, and the node 5 become the established nodes; and the node 3 becomes the next hop between the source node 1 and the destination node 5.

The node 6 that is connected to the node 5 is updated to have the bottleneck equal to 3 and the hop count equal to 3 (FIG. 23).

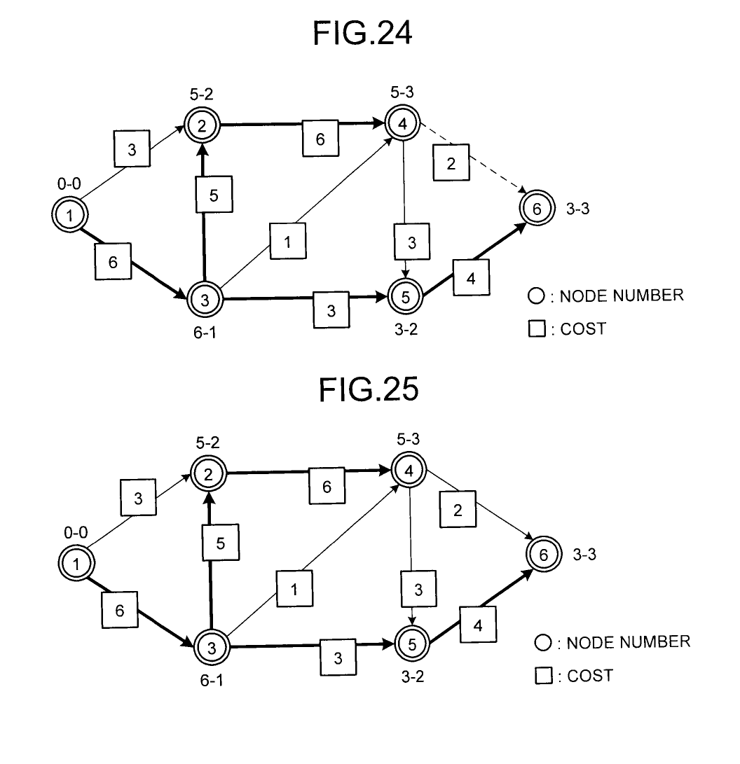

Lastly, regarding the node 6, the shortest path is established with the bottleneck equal to 3 and the hop count equal to 3. Thus, the node 1, the node 3, the node 2, the node 4, the node 5, and the node 6 become the established nodes; and the node 3 becomes the next hop between the source node 1 and the destination node 6 (FIG. 24).

Finally, all the nodes get established and the shortest path tree is completed. The shortest path from the node 1 to the node 6 becomes node 1→node 3→node 5 node 6 (FIG. 25).

Thus, the shortest path tree is acquired in the manner described above. Moreover, the routing tables are created using the shortest path tree. Then, the application keys are shared by referring to the routing tables.

Modification

In the configuration in which each node 100 implements the OSPF protocol and independently holds a routing table; if there are a plurality of paths having the same metric, the source node may select a route different from the best route, and when the destination for sending a key differs from the best path. That happens because each node 100 selects not the best path from the source node but the best path from itself to the destination node.

When such a situation is not desirable, the source node can send a key using a source routing algorithm and can specify in advance the path for sending the key so that it becomes possible to enforce selection of the path determined by the source node. In the source routing algorithm, the path along which the data needs to be sent is determined by the source, and the data transmission is performed along the determined path.

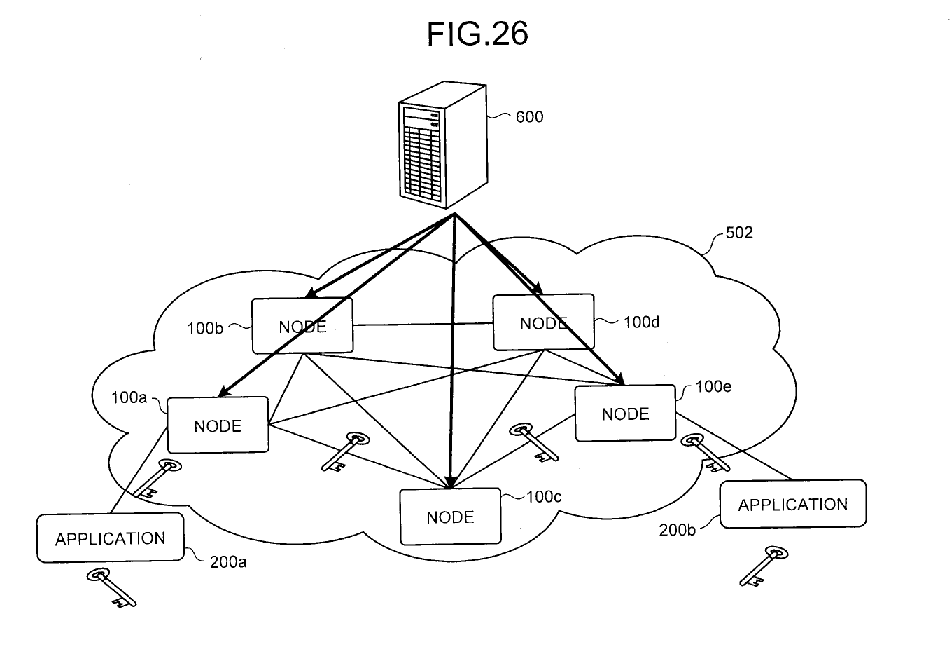

Alternatively, a server can be installed for managing the routing and for specifying the path to send a key. FIG. 26 is a diagram illustrating a configuration example of a quantum cryptographic communication system according to a modification. In the quantum cryptographic communication system according to the modification, a routing management server 600 is installed that calculates the best path and reflects the calculated path in the routing tables held in the nodes 100. That enables each node 100 to select the best path.

Meanwhile, the key resource can vary due to, for example, an increase in the stock of keys as a result of quantum key distribution, or due to a decrease in the stock of keys as a result of application key transmission, or due to a change in the key generation speed as a result of changes in the environment of the quantum cryptogram device. Hence, when such variation in the key resource is detected, the routing protocol according to the embodiment can be re-implemented and the most suitable path can be recalculated. For example, the configuration can be such that the selector 114 compares the resource information (the key generation speed and the stock of keys) acquired at different timings; and, when the amount of change therebetween is equal to or larger than a threshold value, performs the path selection operation (i.e., implements the routing protocol).

In this way, in the communication system according to the embodiment, the routing for sharing cryptographic keys is performed by taking into account the bottleneck and the hop count as the resource. As a result, it becomes possible to reduce the amount of consumption of cryptographic keys in the entire communication system while not only avoiding depletion of cryptographic keys in particular nodes but also maintaining the throughput.

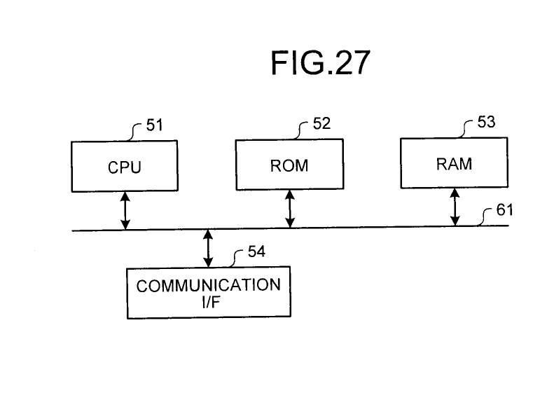

Explained below with reference to FIG. 27 is a hardware configuration of the communication devices (the nodes 100) according to the embodiment. FIG. 27 is an explanatory diagram for explaining a hardware configuration of the communication devices according to the embodiment.

Each communication device according to the embodiment includes a control device such as a central processing unit (CPU) 51; storage devices such as a read only memory (ROM) 52 and a random access memory (RAM) 53; a communication I/F 154 that performs communication by establishing a connection with a network; and a bus 61 that interconnects the other constituent elements.

Meanwhile, the computer programs that are executed in each communication device according to the embodiment are stored in advance in the ROM 52.

Alternatively, the computer programs that are executed in each communication device according to the embodiment can be recorded in the form of installable or executable files in a computer-readable storage medium such as a compact disc read only memory (CD-ROM), a flexible disk (FD), a compact disc readable (CD-R), or a digital versatile disk (DVD); and can be provided as a computer program product.

Still alternatively, the computer programs that are executed in each communication device according to the embodiment can be saved as downloadable files on a computer connected to the Internet or can be made available for distribution through a network such as the Internet.

Meanwhile, the computer programs that are executed in each communication device according to the embodiment can make a computer function as the constituent elements of the abovementioned communication device. In that computer, the CPU 51 reads the computer programs from a computer-readable storage medium and runs them such that the computer programs are loaded in a main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication device configured to be connected to a plurality of external devices, the communication device comprising:
an acquisition unit configured to acquire resource information that represents a resource of cryptographic keys available from each external device; and
a selector configured to select a path from among a plurality of paths for one of the external devices, based on a bottleneck and a hop count of the resource on the path.

2. The communication device according to claim 1, wherein the resource information includes at least one of an available generation speed of the cryptographic keys and an available stock of the cryptographic keys.

3. The communication device according to claim 1, wherein
the selector is configured to select a path having a best bottleneck from among the plurality of paths, and
when there are a plurality of paths having the best bottleneck, the selector selects a path having a smallest hop count from among the plurality of paths having the best bottleneck.

4. The communication device according to claim 1, wherein
the selector is configured to select a path having a smallest hop count from among the plurality of paths, and
when there are a plurality of paths having the smallest hop count, the selector selects a path having a largest bottleneck from among the plurality of paths having the smallest hop count.

5. The communication device according to claim 1, wherein the selector is configured to select a path having a largest metric from among the plurality of paths, the metric having a larger value if the bottleneck is larger and having a larger value if the hop count is smaller.

6. The communication device according to claim 1, wherein
the acquisition unit is configured to acquire first resource information that represents a resource of cryptographic keys available from each external device, and
the acquisition unit is configured to acquire second resource information that represents a resource of cryptographic keys available from the each external device, at a different timing from the first information, and
when an amount of change between the resource represented by the second information and the resource represented by the first information is equal to or larger than a threshold value, the selector selects a path from among the plurality of paths.

7. A communication system comprising a plurality of communication devices each providing a cryptographic key, wherein
each of the communication devices includes
an acquisition unit configured to acquire resource information that represents a resource of cryptographic keys available from each of the other communication devices; and
a selector configured to selects a path from among a plurality of paths for one of the other communication devices, based on a bottleneck and a hop count of the resource on the path.

8. A computer program product comprising a computer-readable medium containing a program executed by a computer connected to a plurality of external devices, the program causing the computer to execute:
acquisition resource information that represents a resource of cryptographic keys available from each external device; and
selecting a path from among a plurality of paths for one of the external devices, based on a bottleneck and a hop count of the resource on the path.
